(19) United States
(12) Patent Application Publication
(10) Pub. No.: US 2023/0036478 A1
(43) Pub. Date: Feb. 2, 2023

(54) Altitude Measuring Device

(71) Applicant: ROHM CO., LTD., Kyoto (JP)

(72) Inventors: Masafumi SEIKE, KYOTO (JP); Tadashi KOBAYASHI, KYOTO (JP)

(21) Appl. No.: 17/874,529

(22) Filed: Jul. 27, 2022

(30) Foreign Application Priority Data
Jul. 30, 2021 (JP) 2021125181

(51) Int. Cl. G01C 5/06; G01K 13/00; G01P 13/00

(52) U.S. Cl. CPC G01C 5/06; G01K 13/00; G01P 13/00

(57) ABSTRACT

The present disclosure provides an altitude measuring device. The altitude measuring device includes: an atmospheric pressure sensor; and a calculation unit, when being turned on, obtaining a measured atmospheric pressure value by the atmospheric pressure sensor as an atmospheric pressure initial value, successively calculating an amount of change of the measured atmospheric pressure value measured by the atmospheric pressure sensor, successively calculating an amount of change of an altitude based on the atmospheric pressure initial value and the amount of change of the measured atmospheric pressure value, and calculating the altitude based on accumulated amount of changes in the altitude.

### TECHNICAL FIELD

The present disclosure relates to an altitude measuring device.

### BACKGROUND

There are altitude measuring devices for measuring altitudes in the prior art. Some altitude measuring devices calculate an altitude by an altitude calculation equation shown in equation (1) below.

$$h = \frac{\left({\left(\frac{{P}_{0}}{P}\right)}^{\frac{1}{5.257}} - 1\right) \times \left(T + 273.15\right)}{0.0065}$$

In equation (1), h represents an altitude (m), P₀ represents a sea level atmospheric pressure (hPa), P represents an atmospheric pressure (hPa) of a current location, and T represents the temperature (°C).

The atmospheric pressure P in equation (1) can use a measured value of an atmospheric pressure sensor of the current location (for example, the atmospheric pressure sensor is as that disclosed in the patent publication 1)

### PRIOR ART DOCUMENT

### Patent Publication

[Patent publication 1] Japan Patent Publication No. 2019-125675

### SUMMARY OF THE PRESENT DISCLOSURE

### Problems to Be Solved by the Present Disclosure

However, the use of equation (1) for calculating an altitude faces an issue of a high computational load. Moreover, it may be difficult to acquire the sea level atmospheric pressure P₀ of high accuracy during altitude measurement, leading to an issue of calculation accuracy of the altitude calculation.

In view of the above situations, it is an object of the present disclosure to provide an altitude measuring device capable of mitigating a computational load and providing good measurement accuracy.

### Technical Means for Solving the Problem

For example, an altitude measuring device of the present disclosure is configured to include: an atmospheric pressure sensor; and a calculation unit, when being turned on, obtaining a measured atmospheric pressure value by the atmospheric pressure sensor as an atmospheric pressure initial value, successively calculating an amount of change of the measured atmospheric pressure value measured by the atmospheric pressure sensor, successively calculating an amount of change of an altitude based on the atmospheric pressure initial value and the amount of change of the measured atmospheric pressure value, and calculating the altitude based on accumulated amount of changes in the altitude.

### Effects of the Present Disclosure

The altitude measuring device of the present disclosure is capable of mitigating a computational load and providing good measurement accuracy.

### BRIEF DESCRIPTION OF THE DRAWINGS

FIG. 1 is a block diagram of a configuration of an altitude measuring device according to a first embodiment.

FIG. 2 is a flowchart associated with an altitude measuring process of the first embodiment.

FIG. 3 is a block diagram of a configuration of an altitude measuring device according to a second embodiment.

FIG. 4 is a flowchart associated with an altitude measuring process of the second embodiment.

FIG. 5 is a block diagram of a configuration of an altitude measuring device according to a third embodiment.

FIG. 6 is a flowchart associated with an altitude measuring process of the third embodiment.

FIG. 7 is a diagram illustrating an example of calculation results of the altitude as time elapses.

FIG. 8 is a block diagram of a configuration of an altitude measuring device according to a variation example of the third embodiment.

FIG. 9 is a diagram illustrating effects of the variation example of the third embodiment.

### DETAILED DESCRIPTION OF THE EMBODIMENTS

Details of the exemplary embodiments are provided with the accompanying drawings below.

### 1. First Embodiment

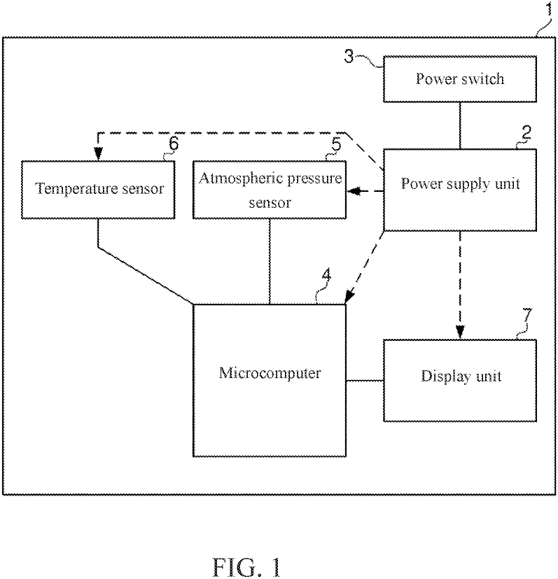

FIG. 1 shows a block diagram of a configuration of an altitude measuring device according to a first embodiment. An altitude measuring device 1 shown in FIG. 1 includes a power supply unit 2, a power switch 3, a microcomputer 4 (or a calculation unit 4), an atmospheric pressure sensor 5, a temperature sensor 6 and a display unit 7. The altitude measuring device 1 may have, for example, a configuration that can be carried by a user.

The power supply unit 2 has a battery (not shown), and a power circuit (not shown) powered by the battery. The power supplied from the power circuit is supplied to the units of the altitude measuring device 1, as shown by dotted lines in FIG. 1.

The power switch 3 is for switching on/off of the power supplied from the power supply unit 2, that is, a switch for turning on/off the power of the altitude measuring device 1.

The microcomputer 4 is configured as a calculation unit capable of implementing the altitude measuring process below.

The atmospheric pressure sensor 5 is a sensor for measuring the atmospheric pressure, and is formed by, for example, a piezoresistive atmospheric pressure sensor. The piezoresistive atmospheric pressure sensor is formed by a micro-electro-mechanical system (MEMS), which uses a monocrystalline silicon plate as a diaphragm, so that impurities diffuse on a surface of the diaphragm to form a resistive bridge circuit. A measurement result of the atmospheric pressure sensor 5 is used for the altitude measuring process.

The temperature sensor 6 is a sensor for measuring the temperature, and is formed by, for example, a thermistor. A measurement result of the temperature sensor 6 is used for the altitude measuring process.

The display unit 7 is configured to display an altitude measured by the microcomputer 4, and is formed by, for example, a liquid crystal display.

The altitude measuring process performed by the altitude measuring device 1 of the first embodiment is described below. Herein, in the altitude measuring process of this embodiment, an altitude is calculated by a calculation equation such as equation (2) below. Equation (2) is derived from equation (1).

$$Δ \text{h=-} \frac{T + 273.15}{0.0065 \times 5.257} \times \frac{Δ P}{{P}_{0}}$$

In equation (2), Ah represents an amount of change (m) in the altitude, P₀ represents a measured value (hPa) of the atmospheric pressure when power is turned on (an atmospheric pressure initial value), AP represents an amount of change (hPa) in a current measured atmospheric pressure value using P₀ as the initial value with respect to a previous measured atmospheric pressure value, and T represents a measured value (°C) of the temperature.

The altitude h can be calculated by successively accumulating Δh calculated by equation (2) with respect to the initial value of the altitude h. Moreover, the initial value of the altitude h is set to, for example, 0.

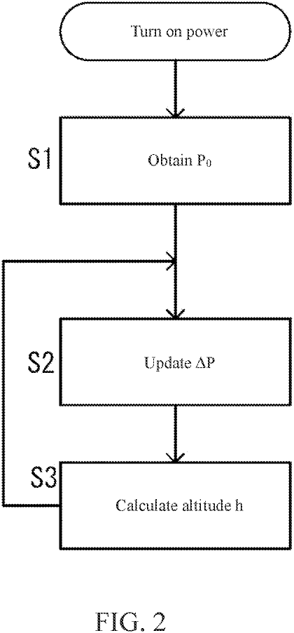

Specific details of the altitude measuring process are described below with reference to the flowchart shown in FIG. 2. When power is turned on through the power switch 3, the process shown in FIG. 2 begins. In step S1, the microcomputer 4 obtains a measurement result of the atmospheric pressure of the atmospheric pressure sensor 5 as P₀ (the atmospheric pressure initial value) in equation (2).

In step S2 that follows, the microcomputer 4 calculates an amount of change in a current measured atmospheric pressure value obtained by the atmospheric pressure sensor 5 with respect to a measured value of a previous round of step S2, and updates ΔP in equation (2) according to a calculation result. When power is turned on for the first time, the current measured atmospheric pressure value is set as P₀ and AP= P₀ - P₀=0. In this case, it is obtained through calculation in step S3 that Ah=0.

In step S3 that follows, the microcomputer 4 uses equation (2) to calculate Δh based on the values of P₀, ΔP and the measurement value (T) of the temperature sensor 6. The microcomputer 4 adds the current calculated Δh with the previous calculated value of the altitude h to calculate the altitude h. In the first time, the altitude h is calculated by setting the previous altitude h to be equal to the initial value of the altitude h. Accordingly, the current altitude h is measured. Moreover, by setting the initial value of the altitude as 0, a relative altitude used as a reference when power is turned on can be measured.

The process returns to step S2 after step S3. Be repeatedly implementing steps S2 and S3, AP is successively updated and Δh is successively calculated, thereby successively calculating the altitude h.

According to this embodiment, since equation (2) is used for calculating the altitude h, the computational load can be mitigated. Thus, the microcomputer 4 with mitigated computational capability can be used, and this is beneficial in terms of costs. Moreover, because the measured atmospheric pressure value when power is turned on is set as P₀ and is used for calculation, calculation can be performed according to the environment when the altitude h is measured, thereby providing good measurement accuracy of the altitude h.

### 2. Second Embodiment

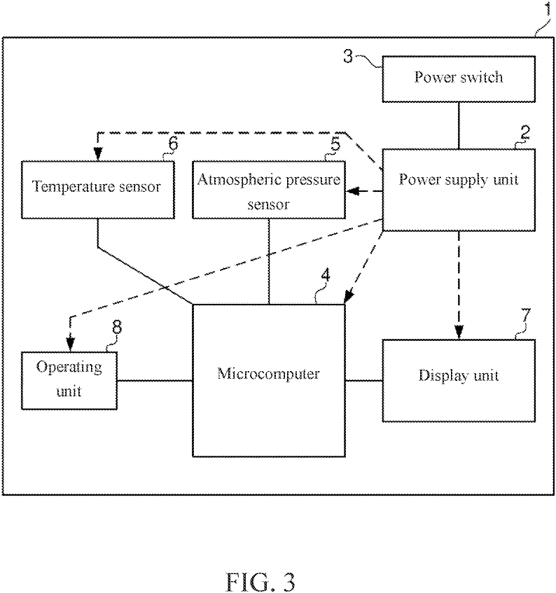

FIG. 3 shows a block diagram of a configuration of an altitude measuring device according to a second embodiment. The altitude measuring device 1 shown in FIG. 3 differs from the configuration of the first embodiment (FIG. 1) in respect of including an operating unit 8.

The operating unit 8 is configured to perform a predetermined operation for updating P₀ (the atmospheric pressure initial value) in equation (2). The predetermined operation may be, for example, pressing a button configured as hardware, or operating on a touch panel of the display unit 7.

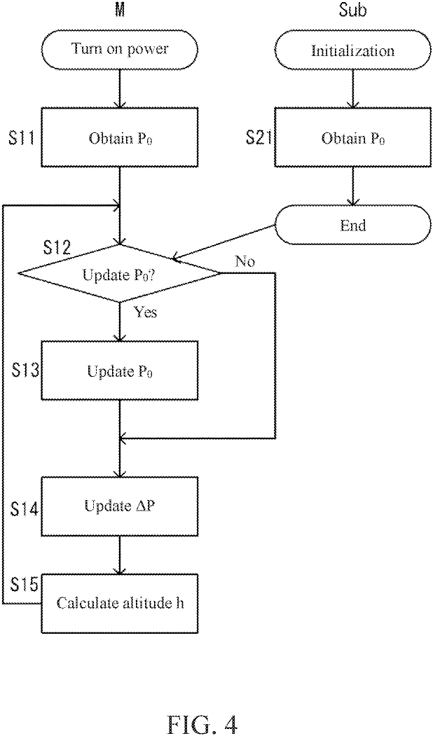

FIG. 4 shows a flowchart of an altitude measuring process of the altitude measuring device 1 of the second embodiment. The altitude measuring process shown in FIG. 4 includes a main process M including steps S11 to S15, and a sub process Sub including step S21.

When power is turned on through the power switch 3, the main process M shown in FIG. 4 begins. Thus, in step S11, the microcomputer 4 obtains a measurement result of the atmospheric pressure of the atmospheric pressure sensor 5 as P₀ (the atmospheric pressure initial value) in equation (2).

In step S12 that follows, the microcomputer 4 determines whether to update P₀.

Herein, the sub process Sub begins when the predetermined operation is performed in the operating unit 8. Thus, in step S21, the microcomputer 4 obtains a measurement result of the atmospheric pressure of the atmospheric pressure sensor 5 as P₀ in equation (2). The sub process Sub is complete (ends) after the obtaining. The sub process Sub is implemented as soon as the predetermined operation is performed.

In step S12, the microcomputer 4 determines whether P₀ is again obtained by the sub process Sub, and update needs to be performed if so (“yes” in step S12). Thus, the process proceeds to step S13, and the microcomputer 4 updates P₀ to the value obtained in step S21. The process proceeds to step S14 below after step S13. In step S12, no update (“no” in step S12) is needed if P₀ is not obtained by the sub process Sub, and the process proceeds to step S14 below instead of step S13.

In step S14, the microcomputer 4 calculates an amount of change in a current measured atmospheric pressure value obtained by the atmospheric pressure sensor 5 with respect to a measured value of a previous round of step S14, and updates ΔP in equation (2) according to a calculation result. When power is turned on for the first time or when P₀ is updated in step S13, the current measured atmospheric pressure value is set as P₀ and ΔP= P₀ - P₀=0. In this case, it is obtained that Δh=0 by the calculation in step S15.

In step S15 that follows, the microcomputer 4 uses equation (2) to calculate Δh based on the values of P₀, ΔP and the measured value (T) of the temperature sensor 6. The microcomputer 4 adds the current calculated Δh with the previous calculated value of the altitude h to calculate the altitude h. In the first time or when P₀ is updated in step S13, the altitude h is calculated by setting the previous altitude h to be equal to the initial value (=0) of the altitude h. Accordingly, the current altitude h is measured. The process returns to step S12 after step S15.

As such, according to this embodiment, update of P₀ and initialization of the altitude h can be performed according to the predetermined operation (an update operation) performed by a user. Thus, an update operation can be performed at a timing at which measuring of the altitude h is actually implemented as desired by a user, hence improving the measurement accuracy of the altitude h. Moreover, the relative altitude h used as a reference at the time of the update operation can be measured.

### 3. Third Embodiment

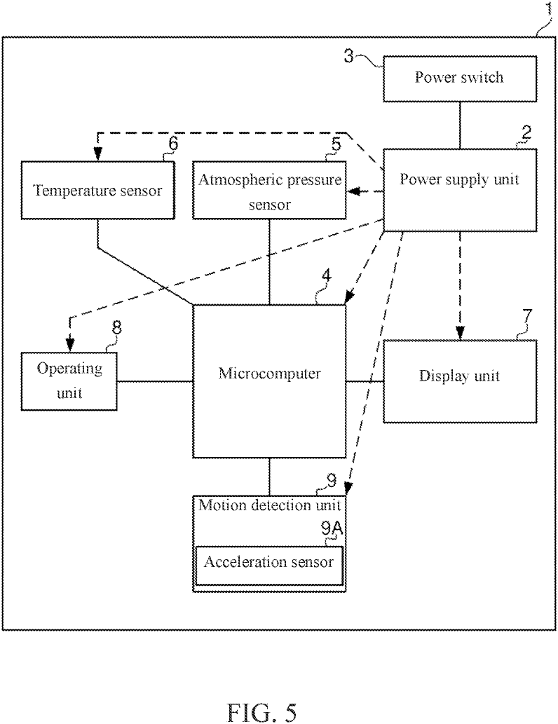

FIG. 5 shows a block diagram of a configuration of the altitude measuring device 1 according to a third embodiment. The altitude measuring device 1 shown in FIG. 5 differs from the configuration of the second embodiment (FIG. 3) in respect of including a motion detection unit 9.

The motion detection unit 9 is configured to be capable of detecting a movement of the altitude measuring device 1 in a vertical direction (the direction of gravity), and has an acceleration sensor 9A. The acceleration in the vertical direction measured by the acceleration sensor 9A is output as the detection result of the motion detection unit 9.

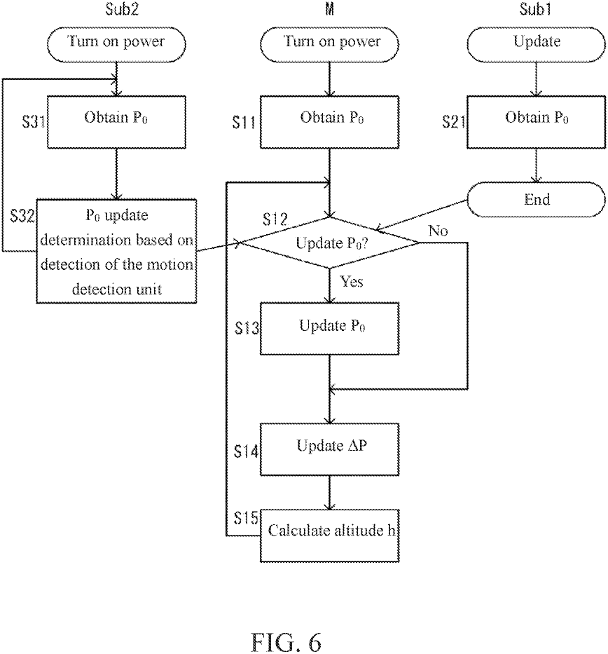

FIG. 6 shows a flowchart of an altitude measuring process of the altitude measuring device 1 of the third embodiment. In addition to including the main process M and a first sub process Sub1 the same as those of the second embodiment, the altitude measuring process shown in FIG. 6 further includes a second sub process Sub2.

When power is turned on, the second sub process Sub2 begins. Thus, in step S31, the microcomputer 4 obtains a measurement result of the atmospheric pressure of the atmospheric pressure sensor 5 as P₀ in equation (2).

In step S32 that follows, the microcomputer 4 determines, based on the detection result of the motion detection unit 9, whether a vertical movement of the altitude measuring device 1 that generates a change in the altitude has occurred, and determines that the P₀ does not need to be updated if so. The microcomputer 4 determines, when it is determined that a vertical movement of the altitude measuring device 1 that generates a change in the altitude has not occurred, that P₀ needs to be updated. That is to say, in step S32, the determination for update of P₀ is performed based on the detection result of the motion detection unit 9.

In the main process M, in step S12, the microcomputer 4 determines according to an update determination result of P₀ in step S32 whether to update P₀. Moreover, when it is determined that P₀ needs to be updated (“yes” in step S12), the process proceeds to step S13, and the microcomputer 4 updates P₀ to the value obtained in step S31. In step S14 that follows, the current measured atmospheric pressure value is set as P₀ and AP= P₀ - P₀=0. Thus, in step S15 that follows, it is calculated that Δh=0, and Δh is added with the previous calculated altitude h. Accordingly, the calculated value of the altitude h is maintained.

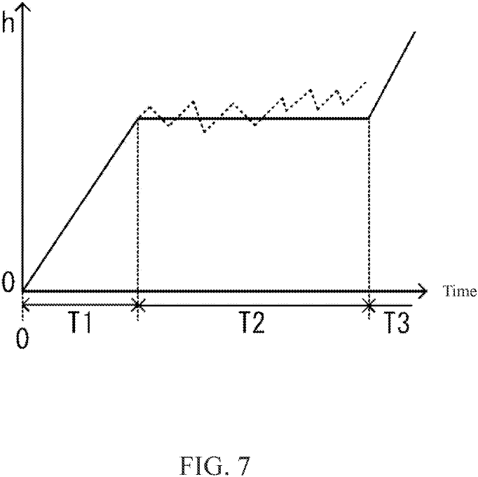

Referring to FIG. 7, a difference between the calculation results of the altitude h in the altitude measuring processes of the first embodiment (FIG. 2) and the third embodiment (FIG. 6) is described below. FIG. 7 is a diagram illustrating an example of calculation results of the altitude as time elapses. The following example is depicted in FIG. 7. Specifically, within a period T1, a user carrying the altitude measuring device 1 walks and the altitude increases; within a period T2, the user stops walking (or walks while maintaining the same altitude); within a period T3, the user walks again so the altitude increases again.

In the example in FIG. 7, in case of the first embodiment, the altitude h rises as time elapses within the period T1 (the solid line). However, within the period T2, although the same altitude is in fact maintained, an error (the dotted lines) of the altitude h is generated due to noise of the measured atmospheric pressure. The noise of the measured atmospheric pressure refers to, for example, a change in the atmospheric pressure caused by typhoons, or a change in the atmospheric pressure caused by air flows (for example, outdoor winds or indoor air flows of air conditioning).

On the contrary, in case of the third embodiment, within the period T1, it is determined in step S32 that a movement of the altitude measuring device 1 in the vertical direction that generates a change in the altitude has occurred, and it is determined that P₀ does not need to be updated. Thus, the process does not proceed to step S13, and the calculated value of the altitude h increases (the solid line).

Then, within the second period T2, it is determined in step S32 that a movement of the altitude measuring device 1 in the vertical direction that generates a change in the altitude has not occurred, and it is determined that P₀ needs to be updated. Thus, P₀ is updated in step S13, and the calculated value of the altitude h is maintained (the solid line). Thus, within the period T2, the calculation result is consistent with the actual state in which the altitude does not increase, hence enhancing the measurement accuracy of the altitude h.

Then, within the period T3, it is determined in step S32 that a movement of the altitude measuring device 1 in the vertical direction that generates a change in the altitude has occurred, and it is determined that P₀ does not need to be updated. Thus, the process does not proceed to step S13, the calculated value of the altitude h again increases (the solid line).

### 4. Variation Example

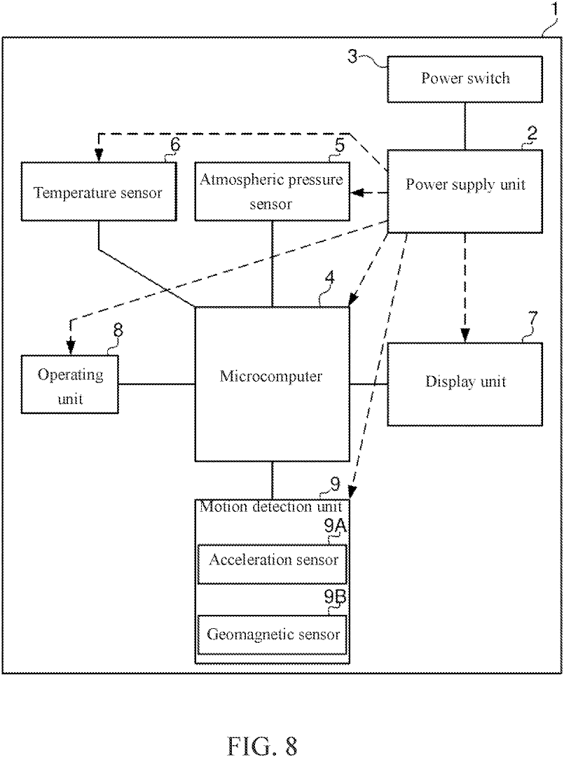

FIG. 8 shows a block diagram of a configuration of the altitude measuring device 1 according to a variation example of the third embodiment. In the altitude measuring device 1 shown in FIG. 8, in addition to including the acceleration sensor 9A, the motion detection unit 9 further includes a geomagnetic sensor 9B.

In this variation example, in the process shown in FIG. 6, in step S32, in addition to considering the detection result of the acceleration sensor 9A, a detection result of the geomagnetic sensor 9B is also taken into account to determine whether a movement of the altitude measuring device 1 in the vertical direction that generates a change in the altitude has occurred.

More specifically, when the acceleration detected by the acceleration sensor 9A is almost 0, in the case where the orientation of the magnetic north does not change or continuously changes based on the detection result of the geomagnetic sensor 9B, it is determined that a movement of the altitude measuring device 1 in the vertical direction that generates a change in the altitude has not occurred. When the acceleration in the vertical direction detected by the acceleration sensor 9A is almost 0, in the case where the orientation of the magnetic north does not change continuously based on the detection result of the geomagnetic sensor 9B, it is determined that a movement of the altitude measuring device 1 in the vertical direction that generates a change in the altitude has occurred.

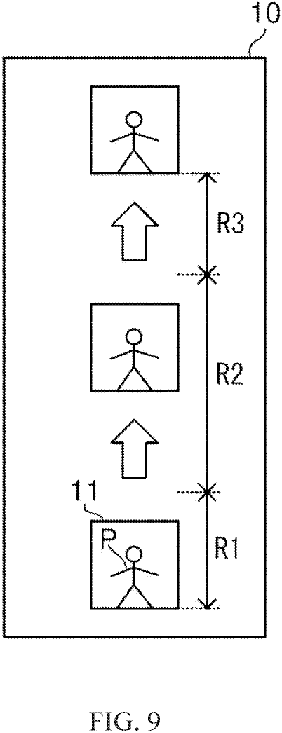

Referring to FIG. 9, details of the effect of such variation example are described below. FIG. 9 shows a diagram illustrating a situation in which a user P carrying the altitude measuring device 1 moves upward by using an elevator 11 in a high-rise building such as a building 10. That is to say, the altitude of the user P increases through the elevator 11.

In this case, as shown in FIG. 9, from low to high in the altitude direction of the building 10, an acceleration region R1, a constant velocity region R2 and a deceleration region R3 are sequentially arranged. In the acceleration region R1 and the deceleration region R3, based on the detection result of the acceleration sensor 9A, it is determined in step S32 that a movement of the altitude measuring device 1 in the vertical direction that generates a change in the altitude has occurred.

In the constant velocity region R2, since the acceleration detected by the acceleration sensor 9A is almost 0, if determination is performed only according to the detection result of the acceleration sensor 9A, it may result in a misjudgment that a movement of the altitude measuring device 1 in the vertical direction that generates a change in the altitude has not occurred. However, with this variation example, in the constant velocity region R2, although the acceleration detected by the acceleration sensor 9A is almost 0, as being affected by the magnetization of the reinforced concrete constituting the building 10, the orientation of the magnetic north does not change continuously based on the detection result of the geomagnetic sensor 9B. Thus, it is determined that a movement of the altitude measuring device 1 in the vertical direction that generates a change in the altitude has occurred. Therefore, update of P₀ in step S13 is not performed, and the calculated value of the altitude h increases.

### 5. Other

The exemplary embodiments are as described above; however, various modifications may be made to the embodiments without departing from the scope of the subject matter of the present disclosure.

For example, in the embodiments, the temperature sensor 6 may be omitted. In this case, in the calculation using equation (2), T is equal to a predetermined constant value. When the measurement result of the temperature sensor 6 is used as T, the calculation accuracy of Ah is improved; however, if high calculation accuracy is not required, the temperature sensor 6 may be omitted to reduce costs.

### 6. Notes

As described above, an altitude measuring device (1) of the present disclosure includes: an atmospheric pressure sensor (5); and a calculation unit (4), when being turned on, obtaining a measured atmospheric pressure value by the atmospheric pressure sensor as an atmospheric pressure initial value (P₀), successively calculating an amount of change (AP) of the measured atmospheric pressure value measured by the atmospheric pressure sensor, successively calculating an amount of change (Ah) of an altitude based on the atmospheric pressure initial value and the amount of change of the measured atmospheric pressure value, and calculating the altitude (h) based on accumulated amount of changes in the altitude (a first configuration).

The first configuration can also be configured as, wherein an initial value of the altitude is set to 0 when a power of the calculation unit (4) is turned on, and the calculation unit (4) calculates the altitude obtained by accumulating the amount of changes in the altitude with respect to the initial value of the altitude (a second configuration).

The first or second configuration can also be configured as, wherein the calculation unit (4), when performing a predetermined operation, updates the atmospheric pressure initial value based on the measured atmospheric pressure value measured by the atmospheric pressure sensor (5) (a third configuration).

The third configuration can also be configured as, wherein the calculation unit (4), when performing the predetermined operation and the initial value of the altitude is set to 0, calculates the altitude obtained by accumulating the amount of changes in the altitude with respect to the initial value of the altitude (a fourth configuration).

The configuration of any one of the first to fourth configurations can also be configured as, further including a motion detection unit (9), capable of detecting a movement of the altitude measuring device (1) in a vertical direction.

wherein the calculation unit (4), based on a detection result of the motion detection unit, determines whether the atmospheric pressure initial value needs to be updated according to the measured atmospheric pressure value measured by the atmospheric pressure sensor (5) (a fifth configuration).

The fifth configuration can also be configured as, wherein the motion detection unit (9) includes an acceleration sensor (9A) (a sixth configuration).

The sixth configuration can also be configured as, wherein the motion detection unit (9) further includes a geomagnetic sensor (9B), and the calculation unit (4), when an acceleration detected by the acceleration sensor (9A) is almost 0, determines whether the atmospheric pressure initial value needs to be updated based on a detection result of the geomagnetic sensor (a seventh configuration).

The configuration of any one of the first to seventh configurations can also be configured as, further including a temperature sensor (6), wherein the calculation unit (4) successively calculates the amount of changes in the altitude based on a detection result (T) of the temperature sensor in addition to the atmospheric pressure initial value and a change in the measured atmospheric pressure value. (an eight configuration).

The configuration of any one of the first to seventh configurations can also be configured as, wherein the calculation unit (4) successively calculates the amount of changes in the altitude based on a fixed temperature (T) in addition to the atmospheric pressure initial value and a change in the measured atmospheric pressure value (a ninth configuration).

### Industrial Applicability

The altitude measuring device of the present disclosure may be applicable to, for example, a device that can be carried by a user.

1. An altitude measuring device, comprising:
an atmospheric pressure sensor; and
a calculation unit, obtaining a measured atmospheric pressure value by the atmospheric pressure sensor when a power is turned on as an atmospheric pressure initial value,
successively calculating an amount of change of the measured atmospheric pressure value measured by the atmospheric pressure sensor,
successively calculating an amount of change of an altitude based on the atmospheric pressure initial value and the amount of change of the measured atmospheric pressure value, and
calculating the altitude based on accumulated amount of changes in the altitude.

2. The altitude measuring device of claim 1, wherein an initial value of the altitude is set to 0 when a power of the calculation unit is turned on, and the calculation unit calculates the altitude obtained by accumulating the amount of changes in the altitude with respect to the initial value of the altitude.

3. The altitude measuring device of claim 1, wherein the calculation unit, when performing a predetermined operation, updates the atmospheric pressure initial value based on the measured atmospheric pressure value measured by the atmospheric pressure sensor.

4. The altitude measuring device of claim 2, wherein the calculation unit, when performing a predetermined operation, updates the atmospheric pressure initial value based on the measured atmospheric pressure value measured by the atmospheric pressure sensor.

5. The altitude measuring device of claim 3, wherein the calculation unit, when performing the predetermined operation and the initial value of the altitude is set to 0, calculates the altitude obtained by accumulating the amount of changes in the altitude with respect to the initial value of the altitude.

6. The altitude measuring device of claim 4, wherein the calculation unit, when performing the predetermined operation and the initial value of the altitude is set to 0, calculates the altitude obtained by accumulating the amount of changes in the altitude with respect to the initial value of the altitude.

7. The altitude measuring device of claim 1, further comprising:
a motion detection unit, capable of detecting a movement of the altitude measuring device in a vertical direction, wherein
the calculation unit, based on a detection result of the motion detection unit, determines whether the atmospheric pressure initial value needs to be updated according to the measured atmospheric pressure value measured by the atmospheric pressure sensor.

8. The altitude measuring device of claim 2, further comprising:
a motion detection unit, capable of detecting a movement of the altitude measuring device in a vertical direction, wherein
the calculation unit, based on a detection result of the motion detection unit, determines whether the atmospheric pressure initial value needs to be updated according to the measured atmospheric pressure value measured by the atmospheric pressure sensor.

9. The altitude measuring device of claim 3, further comprising:
a motion detection unit, capable of detecting a movement of the altitude measuring device in a vertical direction, wherein
the calculation unit, based on a detection result of the motion detection unit, determines whether the atmospheric pressure initial value needs to be updated according to the measured atmospheric pressure value measured by the atmospheric pressure sensor.

10. The altitude measuring device of claim 7, wherein the motion detection unit includes an acceleration sensor.

11. The altitude measuring device of claim 8, wherein the motion detection unit includes an acceleration sensor.

12. The altitude measuring device of claim 10, wherein
the motion detection unit further includes a geomagnetic sensor, and
the calculation unit, when an acceleration detected by the acceleration sensor is almost 0, determines whether the atmospheric pressure initial value needs to be updated based on a detection result of the geomagnetic sensor.

13. The altitude measuring device of claim 1, further comprising:
a temperature sensor, and
the calculation unit, successively calculating the amount of changes in the altitude based on a detection result of the temperature sensor in addition to the atmospheric pressure initial value and a change in the measured atmospheric pressure value.

14. The altitude measuring device of claim 2, further comprising:
a temperature sensor, and
the calculation unit, successively calculating the amount of changes in the altitude based on a detection result of the temperature sensor in addition to the atmospheric pressure initial value and a change in the measured atmospheric pressure value.

15. The altitude measuring device of claim 3, further comprising:
a temperature sensor, and
the calculation unit, successively calculating the amount of changes in the altitude based on a detection result of the temperature sensor in addition to the atmospheric pressure initial value and a change in the measured atmospheric pressure value.

16. The altitude measuring device of claim 5, further comprising:
a temperature sensor, and
the calculation unit, successively calculating the amount of changes in the altitude based on a detection result of the temperature sensor in addition to the atmospheric pressure initial value and a change in the measured atmospheric pressure value.

17. The altitude measuring device of claim 1, wherein the calculation unit successively calculates the amount of changes in the altitude based on a fixed temperature in addition to the atmospheric pressure initial value and a change in the measured atmospheric pressure value.

18. The altitude measuring device of claim 2, wherein the calculation unit successively calculates the amount of changes in the altitude based on a fixed temperature in addition to the atmospheric pressure initial value and a change in the measured atmospheric pressure value.

19. The altitude measuring device of claim 3, wherein the calculation unit successively calculates the amount of changes in the altitude based on a fixed temperature in addition to the atmospheric pressure initial value and a change in the measured atmospheric pressure value.

20. The altitude measuring device of claim 5, wherein the calculation unit successively calculates the amount of changes in the altitude based on a fixed temperature in addition to the atmospheric pressure initial value and a change in the measured atmospheric pressure value.
